(19) United States
(12) Patent Application Publication
(10) Pub. No.: US 2017/0063603 A1
(43) Pub. Date: Mar. 2, 2017

(54) Loop Detection In Dual-Band Repeater Networks

(71) Applicant: MediaTek Singapore Pte. Ltd., Singapore (SG)

(72) Inventors: Prakhar Vig, Ghaziabad (IN); Amit Kumar Shakya, New Delhi (IN); Raghav Monga, Chandigarh (IN); Hasan Ali Stationwala, Indore (IN); Rakesh Lavji Parmar, Maharashtra (IN)

(21) Appl. No.: 15/352,138

(22) Filed: Nov. 15, 2016

(51) Int. Cl. H04L 12/24; H04B 7/15; H04L 29/12

(52) U.S. Cl. CPC H04L 41/0654; H04L 61/6022; H04B 7/15; H04W 88/10

(57) ABSTRACT

A technique for loop detection in repeater networks involves a first communication device of a plurality of communication devices establishing a communication link with a second communication device of the plurality of communication devices. The first communication device transmits to the second communication device a first action frame containing a unique identifier of the first communication device. Upon receiving a second action frame from a third communication device, the first communication device determines whether the second action frame meets a condition related to the unique identifier of the first communication device. Depending on a result of the determination, the first communication device either maintains or disconnects the communication link with the second communication device. The communication link between the first and second communication devices may be on two frequency bands, and loop formation can be detected by either of the first and second communication devices.

### TECHNICAL FIELD

The present disclosure is generally related to computer networking and, more particularly, to loop detection in dual-band repeater networks.

### BACKGROUND

Unless otherwise indicated herein, approaches described in this section are not prior art to the claims listed below and are not admitted to be prior art by inclusion in this section.

In computer networking, a repeater is an electronic device that receives a signal and retransmits the signal at a higher level or higher power so that the signal can be received at a long distance away. Repeaters are devices that can function as both an access point (AP) and a station (STA) (or as both a host and a client), denoted as “repeater_AP” and “repeater_STA” herein, respectively. As a client or repeater_STA, the repeater functions strictly on a channel of repeater_AP, and can connect to another AP and/or repeater_AP. As a host or repeater_AP, a repeater can allow association from other STA's and repeater_STA's. Accordingly, connections between different repeaters can result in mixed topologies such as daisy chain (or line), star, mesh, ring, bus, and so on. Undesirably, in some cases, a loop between repeaters can be formed.

Moreover, loops can be formed in a dual-band network with multiple repeaters. For example, when multiple clients or repeater_STA's on the 2.4 GHz and 5 GHz bands connect to different hosts or repeater_AP's, it is likely that loops would be formed. FIG. 7, FIG. 8 and FIG. 9 illustrate example scenarios 700, 800 and 900, respectively, of loops formation in a dual-band repeater network. Loops need to be avoided as they can choke the network.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose novel schemes that detect, and thus avoid, loop in repeater networks in a fast and efficient way, which leads to link break instead of interface block. The proposed schemes allow nodes in a dual-band repeater network to detect and remove a loop by disconnecting one or more communication links resulting in the formation of the loop. The proposed schemes also avoid looping of broadcast and multicast packets, if both interfaces of a dual-band communication device are connected to the same communication device in a repeater network. For instance, in cases of duplicate links on two frequency bands are established between two nodes, loop formation caused by the duplicate links may be detected and removed.

In one aspect, a method may involve a first communication device (e.g., a first repeater) of a plurality of communication devices (e.g., multiple repeaters) establishing a communication link with a second communication device (e.g., a second repeater) of the plurality of communication devices to connect to the second communication device. The method may also involve the first communication device transmitting to the second communication device a first action frame containing a unique identifier of the first communication device. The method may also involve the first communication device receiving a second action frame from a third communication device that is connected to the first communication device. The method may further involve the first communication device determining whether the second action frame meets a condition related to the unique identifier of the first communication device. For instance, the MAC address of the first communication device may be the highest among a list of MAC addresses contained in the second action frame (e.g., a loop detection frame) received by the first communication device in order to meet the condition. In response to a determination that the second action frame meets the condition, the method may involve the first communication device disconnecting the communication link with the second communication device. In response to a determination that the second action frame does not meet the condition, the method may involve the first communication device maintaining the communication link with the second communication device. Additionally, the first communication device may enter its own unique identifier in the second action frame and forward the action frame to other links.

In another aspect, a method may involve a first communication device (e.g., a first repeater) of a plurality of communication devices (e.g., multiple repeaters) establishing two communication links with a second communication device (e.g., a second repeater) of the plurality of communication devices to connect to the second communication device using a first frequency band and a second frequency band. The method may also involve the first communication device receiving a packet via broadcast or multicast. The method may further involve the first communication device forwarding the packet to at least some of the plurality of communication devices except for one of the plurality of communication devices from which the packet is received. The method may additionally involve the first communication device sending another packet via broadcast or multicast. The method may involve the first communication device forwarding the packet to at least some of the plurality of communication devices except for one of the plurality of communication devices from which the packet is received. In an event that the packet is to be forwarded to the second communication device, the packet may be forwarded over either but not both of the frequency bands.

In another aspect, an apparatus may be implementable in a first communication device (e.g., a first repeater) of a plurality of communication devices (e.g., multiple repeaters). The apparatus may include a memory and a processor. The memory may be configured to store one or more sets of instructions. The processor may be coupled to access the memory to execute the one or more instructions and, upon executing the one or more sets of instructions, the processor is configured to perform a number of operations in accordance with the present disclosure pertaining to loop detection. The processor may establish a communication link with a second communication device of the plurality of communication devices to connect to the second communication device. The processor may transmit, to the second communication device, a first action frame containing a unique identifier of the first communication device. The processor may also receive a second action frame from a third communication device that is connected to the first communication device. The processor may further determine whether the second action frame meets a condition related to the unique identifier of the first communication device. In response to a determination that the second action frame meets the condition, the processor may disconnect the communication link with the second communication device. In response to a determination that the second action frame does not meet the condition, the processor may maintain the communication link with the second communication device. Additionally, the processor may enter the unique identifier of the first communication device in the second action frame and forward the action frame to other interfaces.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example scenario of loop detection in accordance with an implementation of the present disclosure.

FIG. 2 is a diagram of an example scenario of loop detection in accordance with another implementation of the present disclosure.

FIG. 3 is a diagram of an example scenario of loop detection in accordance with another implementation of the present disclosure.

FIG. 4 is a simplified block diagram of an example apparatus in accordance with an implementation of the present disclosure.

FIG. 5 is a flowchart of an example process in accordance with an implementation of the present disclosure.

FIG. 6 is a flowchart of an example process in accordance with another implementation of the present disclosure.

FIG. 7 is a diagram of an example scenario of loop formation in a dual-band repeater network.

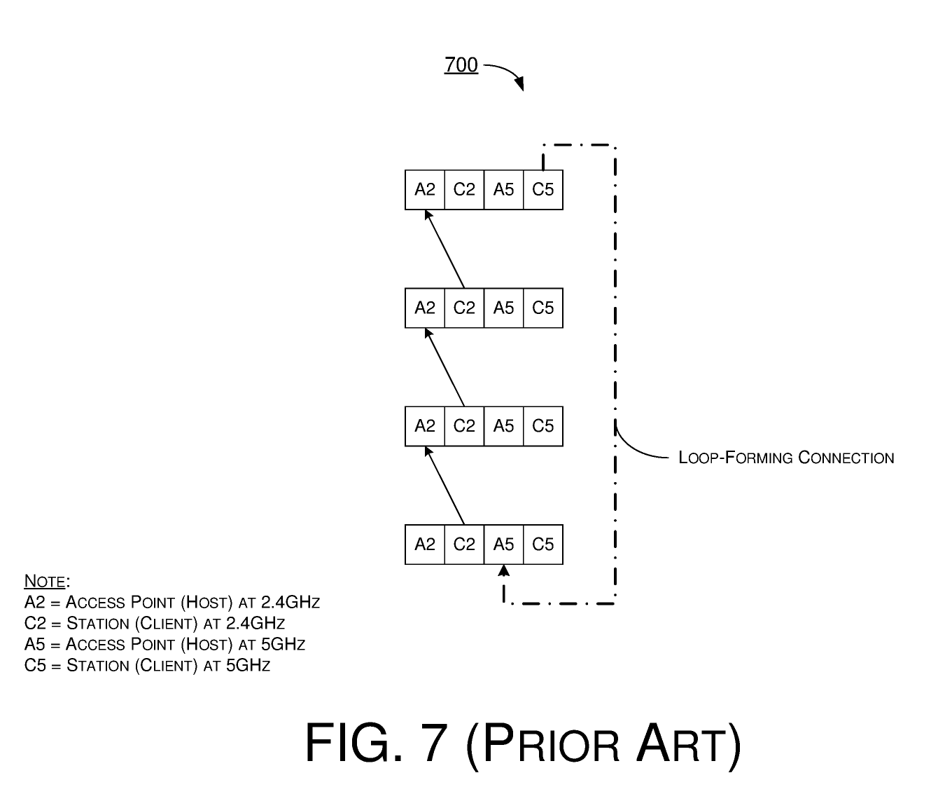

FIG. 8 is a diagram of example scenarios of loop formation in a dual-band repeater network.

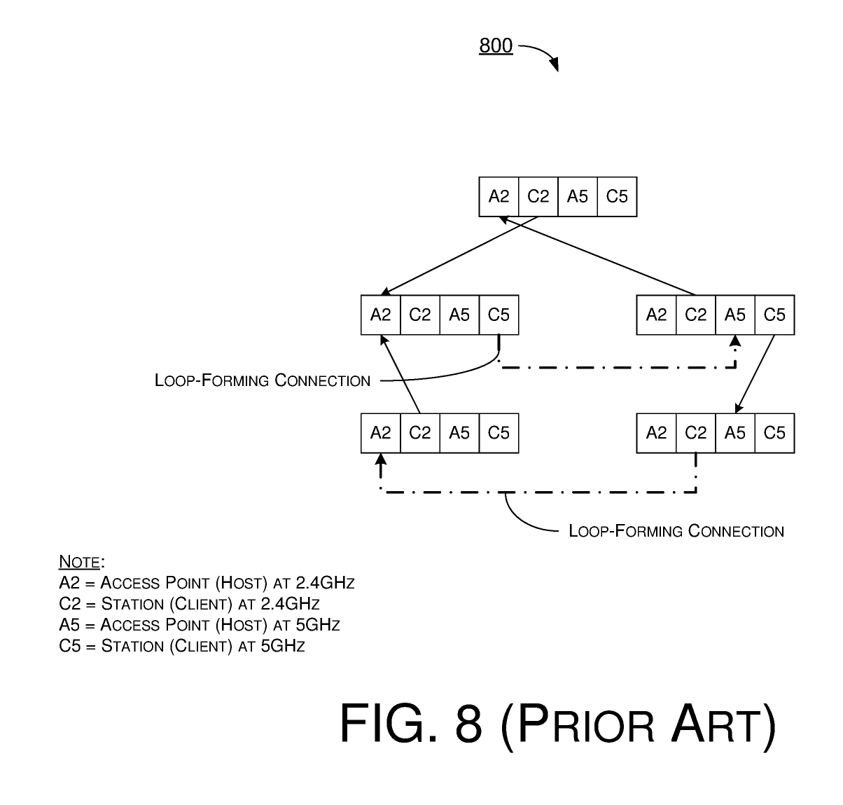

FIG. 9 is a diagram of an example scenario of loop formation in a dual-band repeater network.

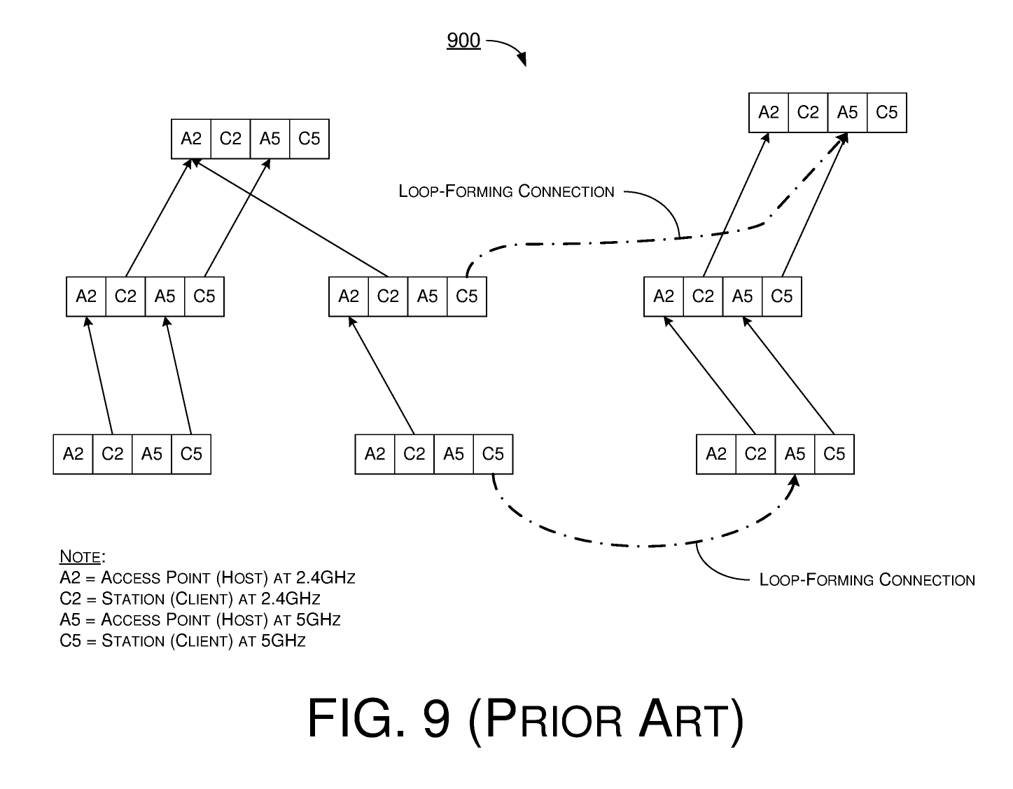

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

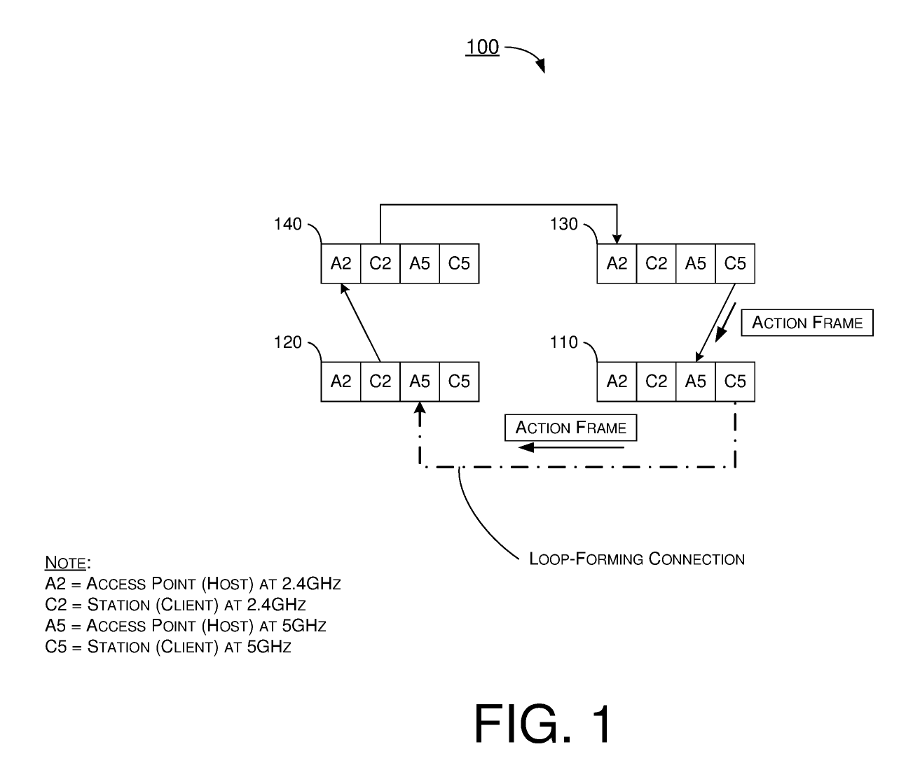

FIG. 1 illustrates an example scenario 100 of loop detection in accordance with an implementation of the present disclosure. In scenario 100, a number of communication devices (e.g., repeaters), such as communication devices 110, 120, 130 and 140, may be dual-band communication devices capable of communications over two frequency bands (e.g., 2.4 GHz and 5 GHz). Each communication device may function as a host, access point or repeater_AP in both of the two frequency bands (labeled as “A2” and “A5” in FIG. 1) and/or as a client, station or repeater_STA in both of the two frequency bands (labeled as “C2” and “C5” in FIG. 1). For example, interfaces A2 and A5 may be host interfaces in the 2.4 GHz and 5 GHz frequency bands, respectively, and interfaces C2 and C5 may be client interfaces in the 2.4 GHz and 5 GHz frequency bands, respectively. In the example shown in FIG. 1, certain communication links may have previously been established between client interface C2 of communication device 120 and host interface A2 of communication device 140, between client interface C2 of communication device 140 and host interface A2 of communication device 130, and between client interface C5 of communication device 130 and host interface A5 of communication device 110.

Under a proposed scheme of the present disclosure, when an interface of one communication device initiates to establish a communication link with an interface of another communication device, a number of rules may apply for loop detection. For instance, after an interface of a communication device (herein interchangeably referred as “initiator”) initiates to establish a communication link with an interface of another communication device, the initiating interface may generate and transmit a loop detection frame, which may be an action frame. As defined in the Institute of Electrical and Electronics Engineers (IEEE) 802.11 specification, an action frame is a generic frame used in the protocol to pass on information from one device to another. Moreover, in cases of simultaneously connections, multiple communication devices may generate and transmit loop detection frames simultaneously.

For illustrative purposes and without limitation, when client interface C5 of communication device 110 initiates to establish a communication link with host interface A5 of communication device 120, other interfaces of communication device 110 such as interfaces C5, A2 and A5 may be refrained from initiating and establishing any communication link with any other communication device. Moreover, host interfaces A2 and A5 may be refrained from accepting any connection. That is, under the proposed scheme, one connection per communication device may be initiated at any given time. After a communication link is established between client interface C5 of communication device 110 and host interface A5 of communication device 120, a loop detection frame (e.g., an action frame) may be transmitted from client interface C5 of communication device 110 to host interface A5 of communication device 120, with the loop detection frame containing a unique identifier (e.g., the media access control (MAC) address) of client interface C5 of communication device 110.

Under the proposed scheme, each interface of a communication device which has generated and transmitted any loop detection frame during this time (e.g., within a predefined time interval of the time at which client interface C5 of communication device 110 initiates to establish a communication link with host interface A5 of communication device 120) may add its respective unique identifier (e.g., MAC address) to a loop detection frame that it receives and then forward that loop detection frame to all other interfaces. For example, in receiving and forwarding the loop detection frame originated from client interface C5 of communication device 110, each of client interface C2 of communication device 120, client interface C2 of communication device 140, and client interface C5 of communication device 130 may append its MAC address to the bottom of a list of MAC addresses contained in that loop detection frame. This way, the list of MAC addresses grows longer and longer, with the MAC address of the originating interface (client interface C5 of communication device 110 in this example) at the top of the list, as the loop detection frame is forwarded from one communication device to another.

Moreover, under the proposed scheme, any interface which is not an initiator of any loop detection frame may not add its unique identifier to a loop detection frame to be forwarded, before forwarding that loop detection frame to all other interfaces. In the instant example, if any of client interface C2 of communication device 120, client interface C2 of communication device 140, and client interface C5 of communication device 130 is not an initiator of any loop detection frame within a predefined time interval, such interface(s) may simply forward on the loop detection frame originated from client interface C5 of communication device 110 without appending its own MAC address to the bottom of a list of MAC addresses contained in that loop detection frame.

Under the proposed scheme, when an initiator receives a loop detection frame, it may check to see if its own unique identifier is listed at the top of a list of unique identifiers contained in that loop detection frame. In an event that the unique identifier of the initiator is listed at the top of the list of unique identifiers contained in that loop detection frame, the initiator may determine that such loop detection frame was originated by itself and the reason why the initiator receives the loop detection frame is that there is a loop. Accordingly, in the event that the MAC address of the initiator is the highest (at the top) in the list, the initiator may disconnect the communication link that was recently established so as to avoid loop formation and to avoid multiple disconnections. In the instant example, when client interface C5 of communication device 110 receives a loop detection frame with the MAC address of client interface C5 of communication device 110 being at the top of a list of MAC addresses contained in the loop detection frame, client interface C5 of communication device 110 may disconnect the communication link between client interface C5 of communication device 110 and host interface A5 of communication device 120.

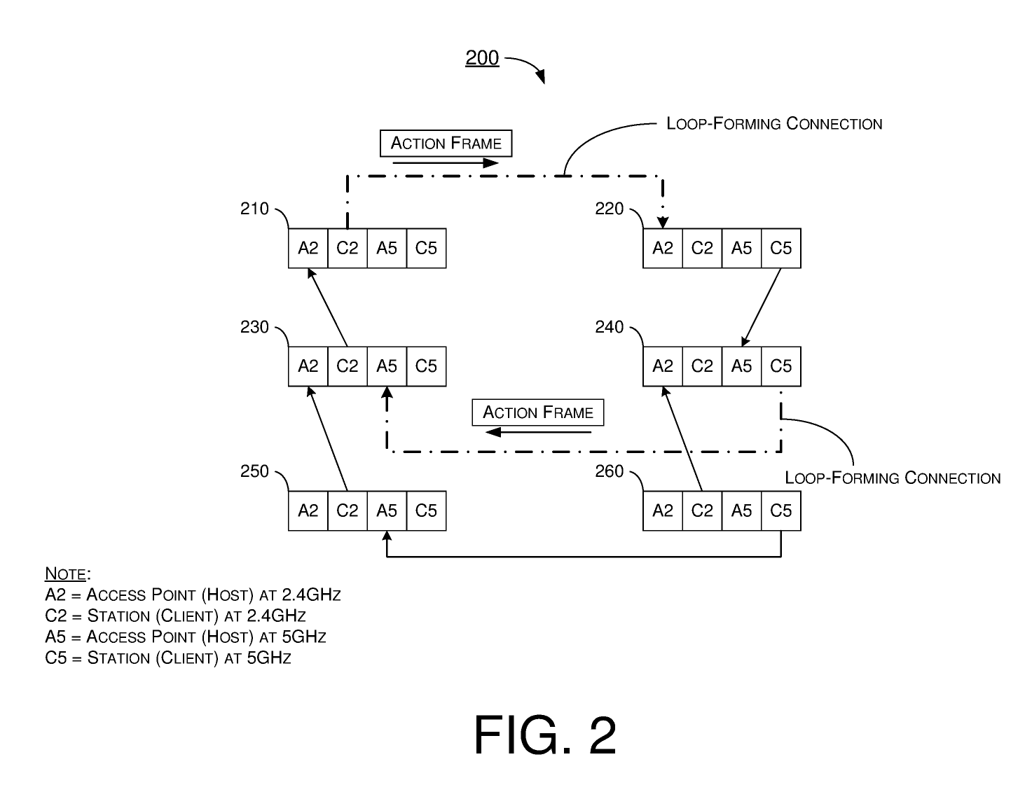

FIG. 2 illustrates an example scenario 200 of loop detection in accordance with another implementation of the present disclosure. In scenario 200, a number of communication devices (e.g., repeaters), such as communication devices 210, 220, 230, 240, 250 and 260, may be dual-band communication devices capable of communications over two frequency bands (e.g., 2.4 GHz and 5 GHz). Each communication device may function as a host, access point or repeater_AP in both of the two frequency bands (labeled as “A2” and “A5” in FIG. 2) and/or as a client, station or repeater_STA in both of the two frequency bands (labeled as “C2” and “C5” in FIG. 2). For example, interfaces A2 and A5 may be host interfaces in the 2.4 GHz and 5 GHz frequency bands, respectively, and interfaces C2 and C5 may be client interfaces in the 2.4 GHz and 5 GHz frequency bands, respectively. In the example shown in FIG. 2, certain communication links may have previously been established between client interface C2 of communication device 230 and host interface A2 of communication device 210, between client interface C2 of communication device 250 and host interface A2 of communication device 230, between client interface C5 of communication device 220 and host interface A5 of communication device 240, between client interface C2 of communication device 260 and host interface A2 of communication device 240, and between client interface C5 of communication device 260 and host interface A5 of communication device 250.

Under another proposed scheme of the present disclosure, when an initiator receives a loop detection frame and finds that its unique identifier is not listed at the top of a list of unique identifiers contained in the loop detection frame (i.e., not the highest among the list of MAC addresses present in the loop detection frame), the initiator may forward that loop detection frame by adding its unique identifier again to the list of unique identifier. Accordingly, the list of unique identifiers contained in that loop detection frame may include two entries of the unique identifier of this initiator. Subsequently, when the initiator receives that loop detection frame again, the initiator may find two entries of its unique identifier in the list of unique identifiers contained in that loop detection frame. In such cases, under the proposed scheme, the initiator may remove the communication link it has recently established with another communication device.

For illustrative purposes and without limitation, when client interface C5 of communication device 240 initiates to establish a communication link with host interface A5 of communication device 230, client interface C5 of communication device 240, as an initiator, may generate and forward a first loop detection frame. At this point the first loop detection frame contains one unique identifier which is that of client interface C5 of communication device 240. Similarly, when client interface C2 of communication device 210 initiates to establish a communication link with host interface A2 of communication device 220, client interface C2 of communication device 210, as another initiator, may generate and forward a second loop detection frame. At this point the second loop detection frame contains one unique identifier which is that of client interface C2 of communication device 210. When client interface C5 of communication device 240 receives the second loop detection frame, it checks and cannot find its unique identifier listed in the second loop detection frame. Client interface C5 of communication device 240 then appends its unique identifier to the bottom of a list of unique identifier(s) contained in the second loop detection frame, and forwards the second loop detection frame. When client interface C2 of communication device 210 receives the first loop detection frame, it checks and cannot find its unique identifier listed in the second loop detection frame. Client interface C2 of communication device 210 then appends its unique identifier to the bottom of a list of unique identifier(s) contained in the first loop detection frame, and forwards the first loop detection frame.

When client interface C5 of communication device 240 receives the first loop detection frame, it finds that its own unique identifier is listed at the top of the list of unique identifiers contained in the first loop detection frame (i.e., being the highest among the list of MAC addresses present in the first loop detection frame). Accordingly, under the proposed scheme, client interface C5 of communication device 240 can proceed to remove the communication link it has established with host interface A5 of communication device 250. As there are multiple loops, looping of the second loop detection frame still continues until it is received by client interface C2 of communication device 210, which originated the second loop detection frame. When client interface C2 of communication device 210 receives the second loop detection frame and finds its own unique identifier not being the highest among the list of unique identifiers (e.g., MAC Addresses) contained in the second loop detection frame, the second loop detection frame may be forwarded again by client interface C2 with the unique identifier (e.g., MAC address) of client interface C2 added once more to the list of unique identifiers in the frame (thus resulting in the unique identifier of client interface C2 being present twice in the list). Upon subsequently receiving the loop detection frame and finding its own unique identifier listed twice, client interface C2 of communication device 210 can proceed to remove the communication link it has established with host interface A2 of communication device 220.

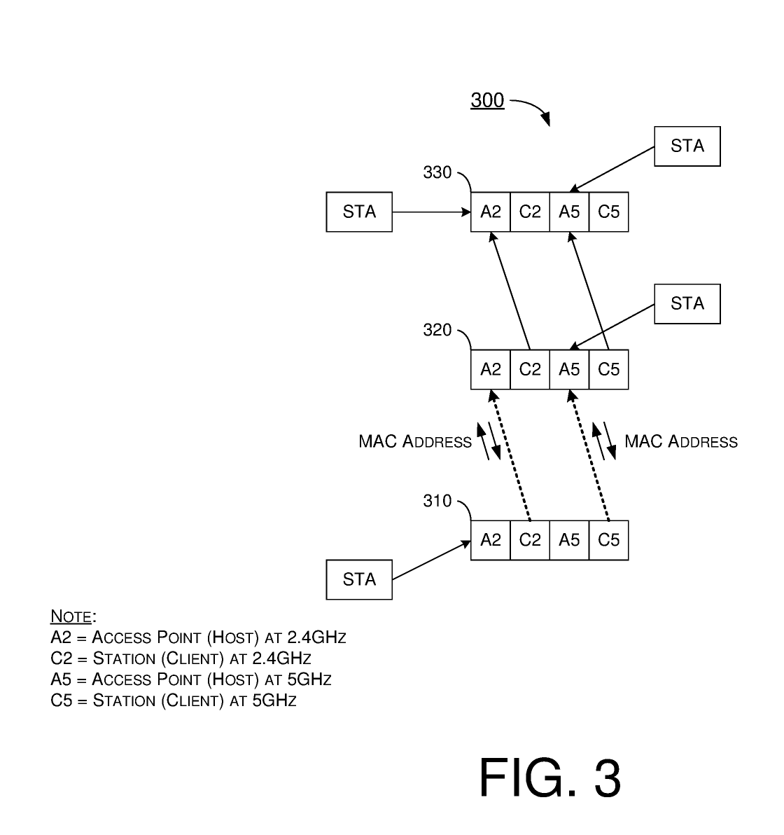

FIG. 3 illustrates an example scenario 300 of loop detection in accordance with another implementation of the present disclosure. In scenario 300, a number of communication devices (e.g., repeaters), such as communication devices 310, 320 and 330, may be dual-band communication devices capable of communications over two frequency bands (e.g., 2.4 GHz and 5 GHz). Each communication device may function as a host, access point or repeater_AP in both of the two frequency bands (labeled as “A2” and “A5” in FIG. 3) and/or as a client, station or repeater_STA in both of the two frequency bands (labeled as “C2” and “C5” in FIG. 3). For example, interfaces A2 and A5 may be host interfaces in the 2.4 GHz and 5 GHz frequency bands, respectively, and interfaces C2 and C5 may be client interfaces in the 2.4 GHz and 5 GHz frequency bands, respectively. In the example shown in FIG. 3, certain communication links may have previously been established between client interface C2 of communication device 320 and host interface A2 of communication device 330, between client interface C5 of communication device 320 and host interface A5 of communication device 330, and between various stations (labeled as “STA” in FIG. 3) and communication devices 310, 320 and 330.

Under an additional proposed scheme of the present disclosure, when a broadcast or multicast packet is received by a first communication device from a second communication device, where two client interfaces of the second communication device are connected to two host interfaces of the first communication device, the first communication device may forward the packet to all communication devices not configured to support loop detection (so-called “non-easy devices) in accordance with the present disclosure. Moreover, the first communication device may forward the packet to all communication devices configured to support loop detection (so-called “easy devices”) in accordance with the present disclosure, except for the second communication device from which the first communication device received the packet.

Under the proposed scheme, when a broadcast or multicast packet is to be sent by a first communication device to a second communication device, where two client interfaces of the second communication device are connected to two host interfaces of the first communication device, the second communication device may forward the packet to all communication devices not configured to support loop detection in accordance with the present disclosure. Moreover, the second communication device may forward the packet to all communication devices configured to support loop detection in accordance with the present disclosure, except for the first communication device from which the second communication device received the packet.

In cases where a frame or packet is to be forwarded from one communication device to another communication device, where there are two communication links (e.g., over two frequency bands) between the two communication devices, the communication device forwarding the frame or packet may forward the frame or packet over either, but not both, of the two communication links. Under the proposed scheme, existence of duplicate links between two communication devices may be detected at one or more host interfaces and/or at one or more client interfaces of either or both of the two communication devices.

For detection of duplicate links between first and second communication devices at one or more client interfaces of the second communication device, during association phase a first host interface of the first communication device may inform a first client interface of the second communication device of the unique identifier (e.g., MAC address) of a second host interface of the first communication device. Likewise, during association phase the second host interface of the first communication device may inform a second client interface of the second communication device of the unique identifier (e.g., MAC address) of the first host interface of the first communication device. For illustrative purposes and without limitation, during association phase host interface A2 of communication device 320 may provide the MAC address of host interface A5 of communication device 320 to client interface C2 of communication device 310 in an association frame. Likewise, during association phase host interface A5 of communication device 320 may provide the MAC address of host interface A2 of communication device 320 to client interface C5 of communication device 310 in an association frame. Accordingly, with one of the communication links (e.g., over the 2.4 GHz frequency band) first established, when the other communication link (e.g., over the 5 GHz frequency band) is being established, each of client interfaces C2 and C5 of communication device 310 may determine and be aware of whether link duplication exists between communication device 310 and communication device 320 by checking the MAC address of the host interface of communication device 320 of the other frequency band and determining whether a link over the other frequency band has been established or not.

For detection of duplicate links between first and second communication devices at one or more host interfaces of the second communication device, during association phase a first client interface of the first communication device may inform a first host interface of the second communication device of the unique identifier (e.g., MAC address) of a second client interface of the first communication device. Likewise, during association phase the second client interface of the first communication device may inform a second host interface of the second communication device of the unique identifier (e.g., MAC address) of the first client interface of the first communication device. For illustrative purposes and without limitation, during association phase client interface C2 of communication device 310 may provide the MAC address of client interface C5 of communication device 310 to host interface A2 of communication device 320 in an association frame. Likewise, during association phase client interface C5 of communication device 310 may provide the MAC address of client interface C2 of communication device 310 to host interface A5 of communication device 320 in an association frame. Accordingly, with one of the communication links (e.g., over the 5 GHz frequency band) first established, when the other communication link (e.g., over the 2.4 GHz frequency band) is being established, each of host interfaces A2 and A5 of communication device 320 may determine and be aware of whether link duplication exists between communication device 310 and communication device 320 by checking the MAC address of the client interface of communication device 310 of the other frequency band and determining whether a link over the other frequency band has been established or not.

### Illustrative Implementations

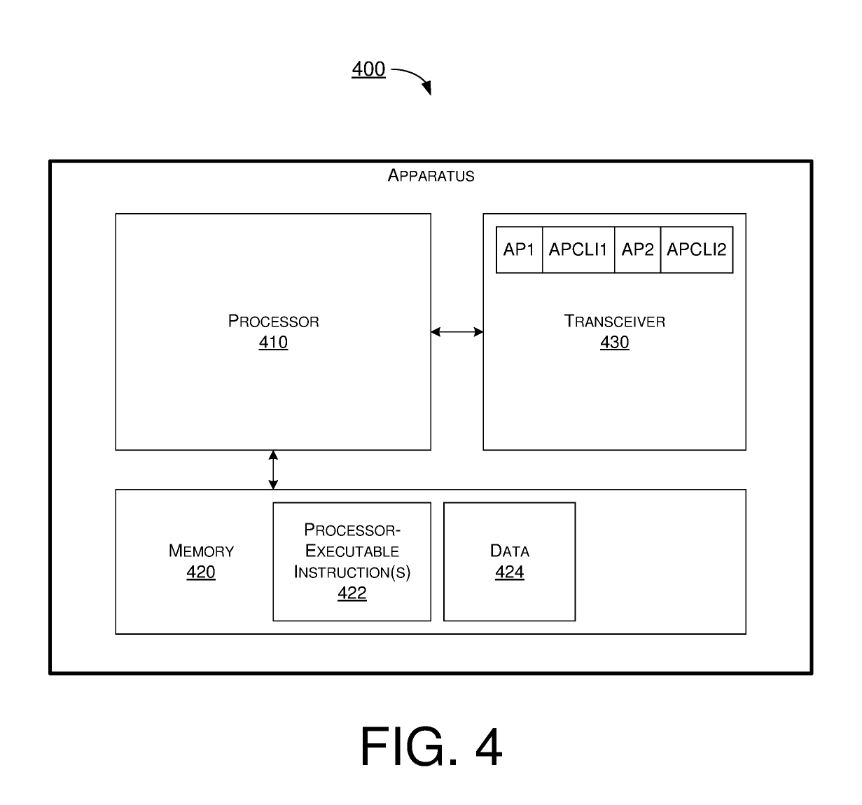

FIG. 4 illustrates an example apparatus 400 in accordance with an implementation of the present disclosure. Apparatus 400 may perform various functions to implement schemes, techniques, processes and methods described herein pertaining to loop detection in dual-band repeater networks, including scenario 100, scenario 200 and scenario 300 described above as well as process 500 and process 600 described below. Apparatus 400 may be a part of an electronic apparatus which may be a communication device, a computing apparatus, a portable or mobile apparatus, or a wearable apparatus. For instance, apparatus 400 may be implemented in a repeater, a Wi-Fi access point, a smartphone, a smartwatch, a smart bracelet, a smart necklace, a personal digital assistant, or a computing device such as a tablet computer, a laptop computer, a notebook computer, a desktop computer, or a server. Alternatively, apparatus 400 may be implemented in the form of one or more integrated-circuit (IC) chips such as, for example and not limited to, one or more single-core processors, one or more multi-core processors, or one or more complex-instruction-set-computing (CISC) processors. Apparatus 400 may include at least some of those components shown in FIG. 4, such as a processor 410 and a memory 420. Additionally, apparatus 400 may include a transceiver 430 configured to transmit and receive data wirelessly (e.g., in compliance with the IEEE 802.11 specification and/or any applicable wireless protocols and standards).

Transceiver 430 may be configured to communicate wirelessly in a first frequency band and a second frequency band. That is, transceiver 430 may be a dual-band communication device capable of communications over two frequency bands (e.g., 2.4 GHz and 5 GHz). Moreover, transceiver 430 may function as a host, access point or repeater_AP in both of the two frequency bands (via host interfaces labeled as “AP1” and “AP2” in FIG. 4). Moreover, transceiver 430 may function as a client, station or repeater_STA in both of the two frequency bands (via client interfaces labeled as “APCLI1” and “APCLI2” in FIG. 4).

Memory 420 may be a storage device configured to store one or more sets of codes, programs and/or instructions 422 as well as data 424 therein. For example, memory 420 may be operatively coupled to processor 410 to receive data 424, such as MAC address(s) of one or more interfaces of one or more other communication devices, to store therein. Memory 420 may be implemented by any suitable technology and may include volatile memory and/or non-volatile memory. For example, memory 420 may include a type of random access memory (RAM) such as dynamic RAM (DRAM), static RAM (SRAM), thyristor RAM (T-RAM) and/or zero-capacitor RAM (Z-RAM).

Alternatively or additionally, memory 420 may include a type of read-only memory (ROM) such as mask ROM, programmable ROM (PROM), erasable programmable ROM (EPROM) and/or electrically erasable programmable ROM (EEPROM). Alternatively or additionally, memory 420 may include a type of non-volatile random-access memory (NVRAM) such as flash memory, solid-state memory, ferroelectric RAM (FeRAM), magnetoresistive RAM (MRAM) and/or phase-change memory.

Processor 410 may be implemented in the form of one or more single-core processors, one or more multi-core processors, or one or more CISC processors. That is, processor 410 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure.

Processor 410 may access memory 420 to execute the one or more instructions stored in memory 420. Upon executing the one or more sets of instructions, processor 410 may be configured to perform operations pertaining to loop detection in dual-band repeater networks in accordance with the present disclosure. For instance, processor 410 may, via transceiver 430, establishing a communication link with a second communication device to connect to the second communication device. Processor 410 may transmit, via transceiver 430, to the second communication device a first action frame containing a unique identifier of the first communication device. The unique identifier may be, for example and without limitation, a MAC address associated apparatus 400 (e.g., a MAC address assigned to transceiver 430). Processor 410 may also receive, via transceiver 430, a second action frame from a third communication device. Processor 410 may determine whether the second action frame meets a condition related to the unique identifier of the first communication device. In response to a determination that the second action frame meets the condition, processor 410 may disconnect the communication link with the second communication device. In response to a determination that the second action frame does not meet the condition, processor 410 may maintain the communication link with the second communication device. Additionally, processor 410 may enter the unique identifier of the first communication device in the second action frame and forward the action frame to other interfaces.

In some implementations, in establishing the communication link with the second communication device, processor 410 may establish the communication link with the second communication device, via transceiver 430, using a first frequency band of two frequency bands with which transceiver 430 is configured to establish communication links. Moreover, processor 410 may refrain from initiating to establish any communication link with any communication device, via transceiver 430, using a second frequency band of the two frequency bands when establishing the communication link with the second communication device using the first frequency band. Furthermore, processor 410 may refrain host interfaces AP1 and AP2 from accepting any connection.

In some implementations, the second action frame may contain a plurality of unique identifiers of a plurality of communication devices each of which having established a respective communication link within a predefined time interval. For instance, each of those communication devices having recently initiated to establish a communication link within the predefined time interval (e.g., 10 milliseconds, 100 milliseconds or 1 second), upon receiving the action frame from another communication device, may add its unique identifier (e.g., MAC address) to an action frame by appending its unique identifier to the bottom of a list of unique identifier contained in the action frame. As a result, as the action frame is forwarded from one communication device to another, the list of unique identifiers may grow.

In some implementations, in determining whether the second action frame meets the condition related to the unique identifier of the first communication device, processor 410 may perform a number of operations. For instance, processor 410 may identify a highest unique identifier at top of a list of a plurality of unique identifiers of a plurality of communication devices contained in the second action frame. Processor 410 may also determine whether the highest unique identifier is the unique identifier of the first communication device. In response to a determination that the highest unique identifier is the unique identifier of the first communication device, processor 410 may determine that the second action frame meets the condition related to the unique identifier of the first communication device. In response to a determination that the highest unique identifier is not the unique identifier of the first communication device, processor 410 may determine that the second action frame does not meet the condition related to the unique identifier of the first communication device.

Alternatively or additionally, in determining whether the second action frame meets the condition related to the unique identifier of the first communication device, processor 410 may perform other operations. For instance, processor 410 may determine whether the unique identifier of the first communication device is listed twice in a list of a plurality of unique identifiers of a plurality of communication devices contained in the second action frame. In response to a determination that the unique identifier of the first communication device is listed twice in the list of the plurality of unique identifiers, processor 410 may determine that the second action frame meets the condition related to the unique identifier of the first communication device. In response to a determination that the unique identifier of the first communication device is listed once in the list of the plurality of unique identifiers and not at top of the list, processor 410 may determine that the second action frame does not meet the condition related to the unique identifier of the first communication device. In short, processor 410 may check whether the unique identifier of the first communication device (e.g., a MAC address associated with the first communication device) is present in the action frame, and may disconnect the communication link when at least one of the following conditions is true: (1) the unique identifier of the first communication device being the highest among all unique identifiers in the list, and (2) the unique identifier of the first communication device being present twice in the list.

In some implementations, in response to the determination that the second action frame does not meet the condition, processor 410 may add the unique identifier of apparatus 400 to bottom of a list of unique identifiers of a plurality of communication devices contained in the second action frame. Moreover, processor 410 may forward the second action frame to the second communication device and/or any other communication device with which processor 410 has established communication links via transceiver 430.

In some implementations, processor 410 may establish two communication links with a second communication device, via transceiver 430, to connect to the second communication device using a first frequency band and a second frequency band. Processor 410 may also receive, via transceiver 430, a broadcast or multicast packet. Processor 410 further forward, via transceiver 430, the packet to at least some of the plurality of communication devices except for one of the plurality of communication devices from which the packet is received.

In some implementations, in receiving the packet, processor 410 may receive, via transceiver 430, the packet from a third communication device of the plurality of communication devices. Additionally, in forwarding the packet, processor 410 may forward the packet, via transceiver 430, to the second communication device on either but not both of the two communication links.

In some implementations, the plurality of communication devices may include a first type of one or more communication devices not configured to support loop detection in accordance with the present disclosure. The plurality of communication devices may also include a second type of one or more communication devices configured to support loop detection in accordance with the present disclosure. Accordingly, in forwarding the packet to at least some of the plurality of communication devices except for one of the plurality of communication devices from which the packet is received, processor 410 may forward the packet, via transceiver 430, to every communication device of the one or more communication devices of the first type. Moreover, processor 410 may forward the packet, via transceiver 430, to every communication device of the one or more communication devices of the second type except for the one of the plurality of communication devices from which the packet is received.

In some implementations, in establishing the two communication links with the second communication device, processor 410 may establish, via transceiver 430, a first communication link between a first host interface of transceiver 430 and a first client interface of the second communication device using the first frequency band, and establish, via transceiver 430, a second communication link between a second host interface of transceiver 430 and a second client interface of the second communication device using the second frequency band. In some implementations, processor 410 may provide, via transceiver 430, a MAC address of the second host interface of transceiver 430 to the second communication device during an association phase between the first host interface of transceiver 430 and the first client interface of the second communication device. Moreover, processor 410 may provide, via transceiver 430, a MAC address of the first host interface of transceiver 430 to the second communication device during an association phase between the second host interface of transceiver 430 and the second client interface of the second communication device. Alternatively or additionally, processor 410 may receive, via transceiver 430, a MAC address of the second client interface of the second communication device from the second communication device during an association phase between the first host interface of transceiver 430 and the first client interface of the second communication device. Furthermore, processor 410 may receive, via transceiver 430, a MAC address of the first client interface of the second communication device from the second communication device during an association phase between the second host interface of transceiver 430 and the second client interface of the second communication device. Accordingly, processor 410 may detect whether the first communication link and the second communication link are duplicate of one another based on the MAC address of the first client interface and the MAC address of the second client interface of the second communication device.

In some implementations, in establishing the two communication links with the second communication device, processor 410 may establish, via transceiver 430, a first communication link between a first client interface of transceiver 430 and a first host interface of the second communication device using the first frequency band. Additionally, processor 410 may establish, via transceiver 430, a second communication link between a second client interface of transceiver 430 and a second host interface of the second communication device using the second frequency band. In some implementations, processor 410 may provide, via transceiver 430, a MAC address of the second client interface of transceiver 430 to the second communication device during an association phase between the first client interface of transceiver 430 and the first host interface of the second communication device. Moreover, processor 410 may provide, via transceiver 430, a MAC address of the first client interface of transceiver 430 to the second communication device during an association phase between the second client interface of transceiver 430 and the second host interface of the second communication device. Alternatively or additionally, processor 410 may receive, via transceiver 430, a MAC address of the second host interface of the second communication device from the second communication device during an association phase between the first client interface of transceiver 430 and the first host interface of the second communication device. Furthermore, processor 410 may receive, via transceiver 430, a MAC address of the first host interface of the second communication device from the second communication device during an association phase between the second client interface of transceiver 430 and the second host interface of the second communication device. Accordingly, processor 410 may detect whether the first communication link and the second communication link are duplicate of one another based on the MAC address of the first host interface and the MAC address of the second host interface of the second communication device.

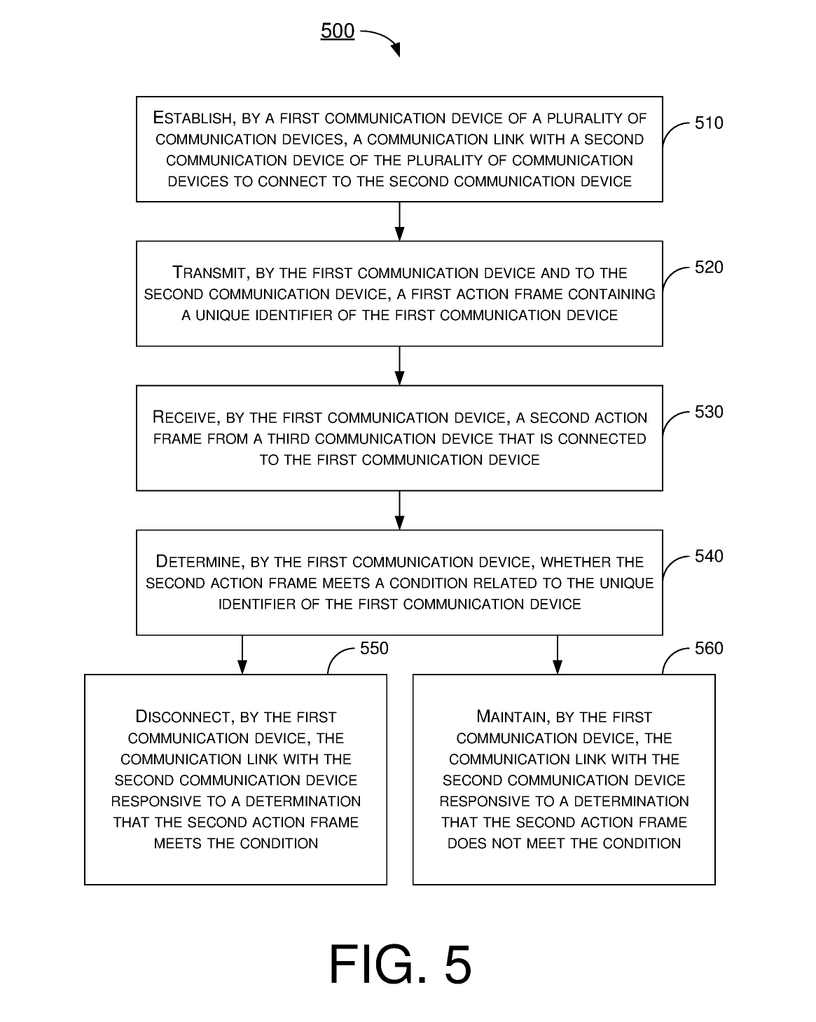

FIG. 5 illustrates an example process 500 in accordance with an implementation of the present disclosure. Process 500 may represent an aspect of implementing features of apparatus 400. Process 500 may include one or more operations, actions, or functions as illustrated by one or more of blocks 510, 520, 530, 540, 550 and 560. Although illustrated as discrete blocks, various blocks of process 500 may be divided into additional blocks, combined into fewer blocks, or eliminated, depending on the desired implementation. Moreover, the blocks/sub-blocks of process 500 may executed in the order shown in FIG. 5 or, alternatively in a different order. Process 500 may be implemented by apparatus 400 and any variations thereof. For instance, process 500 may be implemented in and by each of the communication devices, nodes or repeaters shown in FIG. 1, FIG. 2 and FIG. 3. Solely for illustrative purposes, process 500 is described below in the context of apparatus 400 being a first communication device (e.g., first repeater) of a plurality of communication devices (e.g., multiple repeaters). Process 500 may begin at block 510.

At 510, process 500 may involve processor 410 of apparatus 400 establishing, via transceiver 430, a communication link with a second communication device of the plurality of communication devices to connect to the second communication device. Process 500 may proceed from 510 to 520.

At 520, process 500 may involve processor 410 of apparatus 400 transmitting, via transceiver 430, to the second communication device a first action frame containing a unique identifier of the first communication device. Process 500 may proceed from 520 to 530.

At 530, process 500 may involve processor 410 of apparatus 400 receiving, via transceiver 430, a second action frame from a third communication device that is connected to the first communication device. Process 500 may proceed from 530 to 540.

At 540, process 500 may involve processor 410 of apparatus 400 determining whether the second action frame meets a condition related to the unique identifier of the first communication device. Process 500 may proceed from 540 to either 550 or 560.

At 550, process 500 may involve processor 410 of apparatus 400 disconnecting, via transceiver 430, the communication link with the second communication device in response to a determination that the second action frame meets the condition.

At 560, process 500 may involve processor 410 of apparatus 400 maintaining, via transceiver 430, the communication link with the second communication device in response to a determination that the second action frame does not meet the condition. Additionally, process 500 may involve processor 410 entering the unique identifier of the first communication device in the second action frame and forwarding the action frame to other interfaces.

In some implementations, the unique identifier comprises a MAC address of the first communication device.

In some implementations, in establishing the communication link with the second communication device, process 500 may involve processor 410 performing a number of operations. For instance, process 500 may involve processor 410 establishing the communication link with the second communication device using a first frequency band of two frequency bands with which the first communication device is configured to establish communication links. Additionally, process 500 may involve processor 410 refraining from initiating to establish any communication link with any communication device using a second frequency band of the two frequency bands when establishing the communication link with the second communication device using the first frequency band. Process 500 may also involve processor 410 refraining each host interface of apparatus 400 from accepting any connection.

In some implementations, the second action frame contains a plurality of unique identifiers (e.g., MAC addresses) of a plurality of communication devices each of which having established a respective communication link within a predefined time interval.

In some implementations, in determining whether the second action frame meets the condition related to the unique identifier of the first communication device, process 500 may involve processor 410 performing a number of operations. For instance, process 500 may involve processor 410 identifying a highest unique identifier at top of a list of a plurality of unique identifiers of a plurality of communication devices contained in the second action frame. Additionally, process 500 may involve processor 410 determining whether the highest unique identifier is the unique identifier of the first communication device. Moreover, process 500 may involve processor 410 determining that the second action frame meets the condition related to the unique identifier of the first communication device in response to a determination that the highest unique identifier is the unique identifier of the first communication device. Furthermore, process 500 may involve processor 410 determining that the second action frame does not meet the condition related to the unique identifier of the first communication device in response to a determination that the highest unique identifier is not the unique identifier of the first communication device.

Alternatively or additionally, in determining whether the second action frame meets the condition related to the unique identifier of the first communication device, process 500 may involve processor 410 performing other operations. For instance, process 500 may involve processor 410 determining whether the unique identifier of the first communication device is listed twice in a list of a plurality of unique identifiers of a plurality of communication devices contained in the second action frame. Moreover, process 500 may involve processor 410 determining that the second action frame meets the condition related to the unique identifier of the first communication device in response to a determination that the unique identifier of the first communication device is listed twice in the list of the plurality of unique identifiers. Furthermore, process 500 may involve processor 410 determining that the second action frame does not meet the condition related to the unique identifier of the first communication device in response to a determination that the unique identifier of the first communication device is listed once in the list of the plurality of unique identifiers and not at top of the list.

In some implementations, in response to the determination that the second action frame does not meet the condition, process 500 may involve processor 410 performing a number of operations. For instance, process 500 may involve processor 410 adding the unique identifier of the first communication device to bottom of a list of unique identifiers of a plurality of communication devices contained in the second action frame. Additionally, process 500 may involve processor 410 forwarding the second action frame to the second communication device.

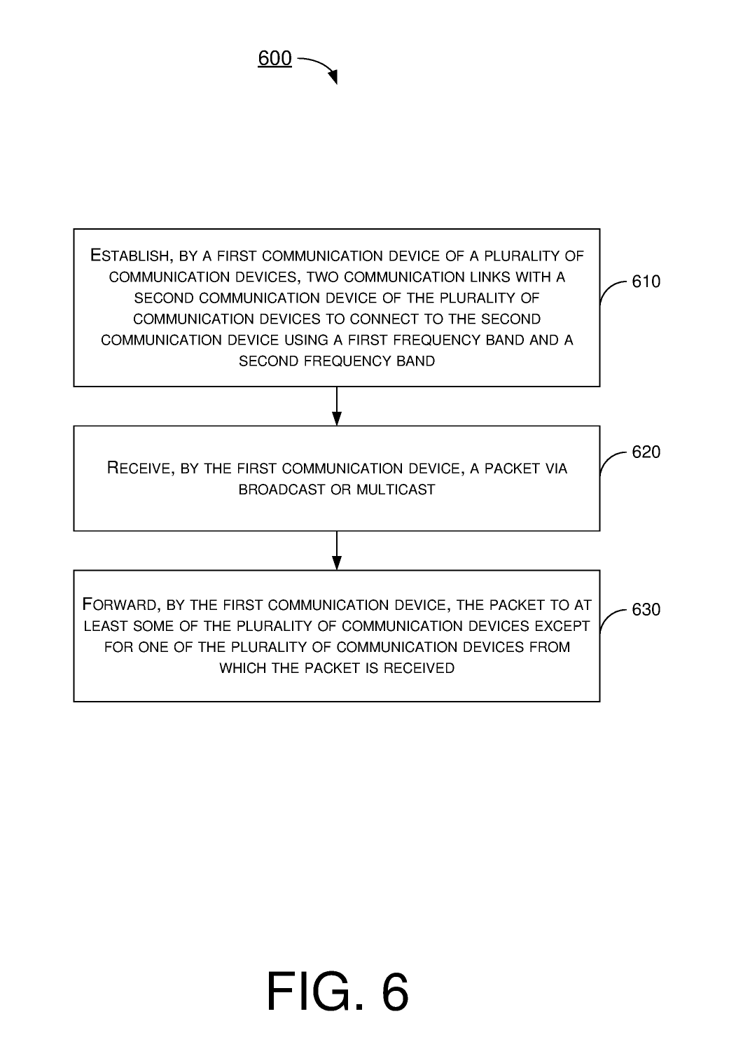

FIG. 6 illustrates an example process 600 in accordance with an implementation of the present disclosure. Process 600 may represent an aspect of implementing features of apparatus 400. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks/sub-blocks of process 600 may executed in the order shown in FIG. 6 or, alternatively in a different order. Process 600 may be implemented by apparatus 400 and any variations thereof. For instance, process 600 may be implemented in and by each of the communication devices, nodes or repeaters shown in FIG. 1, FIG. 2 and FIG. 3. Solely for illustrative purposes, process 600 is described below in the context of apparatus 400 being a first communication device (e.g., first repeater) of a plurality of communication devices (e.g., multiple repeaters). Process 600 may begin at block 610.

At 610, process 600 may involve processor 410 of apparatus 400 establishing, via transceiver 430, two communication links with a second communication device of the plurality of communication devices to connect to the second communication device using a first frequency band and a second frequency band. Process 600 may proceed from 610 to 620.

At 620, process 600 may involve processor 410 of apparatus 400 receiving, via transceiver 430, a packet via broadcast or multicast. Process 600 may proceed from 620 to 630.

At 630, process 600 may involve processor 410 of apparatus 400 forwarding, via transceiver 430, the packet to at least some of the plurality of communication devices except for one of the plurality of communication devices from which the packet is received.

In some implementations, in receiving the packet, process 600 may involve processor 410 receiving the packet, via transceiver 430, from a third communication device of the plurality of communication devices. Moreover, in forwarding the packet, process 600 may involve processor 410 forwarding the packet, via transceiver 430, to the second communication device on either but not both of the two communication links.

In some implementations, the plurality of communication devices may include a first type of one or more communication devices not configured to support loop detection in accordance with the present disclosure. Moreover, the plurality of communication devices may also include a second type of one or more communication devices configured to support loop detection in accordance with the present disclosure. In some implementations, in forwarding the packet to at least some of the plurality of communication devices except for one of the plurality of communication devices from which the packet is received, process 600 may involve processor 410 forwarding the packet, via transceiver 430, to every communication device of the one or more communication devices of the first type. Additionally, process 600 may involve processor 410 forwarding the packet, via transceiver 430, to every communication device of the one or more communication devices of the second type except for the one of the plurality of communication devices from which the packet is received.

In some implementations, in establishing the two communication links with the second communication device, process 600 may involve processor 410 establishing, via transceiver 430, a first communication link between a first host interface of transceiver 430 and a first client interface of the second communication device using the first frequency band. Moreover, process 600 may involve processor 410 establishing, via transceiver 430, a second communication link between a second host interface of transceiver 430 and a second client interface of the second communication device using the second frequency band. Accordingly, in establishing the first communication link between the first host interface of transceiver 430 and the first client interface of the second communication device using the first frequency band, process 600 may involve processor 410 providing, via transceiver 430, a MAC address of the second host interface of transceiver 430 to the second communication device during an association phase between the first host interface of transceiver 430 and the first client interface of the second communication device. Additionally, in establishing the second communication link between the second host interface of transceiver 430 and the second client interface of the second communication device using the second frequency band, process 600 may involve processor 410 providing, by transceiver 430, a MAC address of the first host interface of transceiver 430 to the second communication device during an association phase between the second host interface of transceiver 430 and the second client interface of the second communication device.

In some implementations, in establishing the two communication links with the second communication device, process 600 may involve processor 410 establishing, via transceiver 430, a first communication link between a first host interface of transceiver 430 and a first client interface of the second communication device using the first frequency band. Additionally, process 600 may involve processor 410 establishing, via transceiver 430, a second communication link between a second host interface of transceiver 430 and a second client interface of the second communication device using the second frequency band. Accordingly, in establishing the first communication link between the first host interface of transceiver 430 and the first client interface of the second communication device using the first frequency band, process 600 may involve processor 410 receiving, via transceiver 430, a MAC address of the second client interface of the second communication device from the second communication device during an association phase between the first host interface of transceiver 430 and the first client interface of the second communication device. Moreover, in establishing the second communication link between the second host interface of transceiver 430 and the second client interface of the second communication device using the second frequency band, process 600 may involve processor 410 receiving, via transceiver 430, a MAC address of the first client interface of the second communication device from the second communication device during an association phase between the second host interface of transceiver 430 and the second client interface of the second communication device. Thus, processor 410 may detect whether the first communication link and the second communication link are duplicate of one another based on the MAC address of the first client interface and the MAC address of the second client interface of the second communication device.

In some implementations, in establishing the two communication links with the second communication device, process 600 may involve processor 410 establishing, via transceiver 430, a first communication link between a first client interface of transceiver 430 and a first host interface of the second communication device using the first frequency band. Additionally, process 600 may involve processor 410 establishing, via transceiver 430, a second communication link between a second client interface of transceiver 430 and a second host interface of the second communication device using the second frequency band. Accordingly, in establishing the first communication link between the first client interface of transceiver 430 and the first host interface of the second communication device using the first frequency band, process 600 may involve processor 410 providing, via transceiver 430, a MAC address of the second client interface of transceiver 430 to the second communication device during an association phase between the first client interface of transceiver 430 and the first host interface of the second communication device. Furthermore, in establishing the second communication link between the second client interface of transceiver 430 and the second host interface of the second communication device using the second frequency band, process 600 may involve processor 410 providing, via transceiver 430, a MAC address of the first client interface of transceiver 430 to the second communication device during an association phase between the second client interface of transceiver 430 and the second host interface of the second communication device.

In some implementations, in establishing the two communication links with the second communication device, process 600 may involve processor 410 establishing, via transceiver 430, a first communication link between a first client interface of transceiver 430 and a first host interface of the second communication device using the first frequency band. Additionally, process 600 may involve processor 410 establishing, via transceiver 430, a second communication link between a second client interface of transceiver 430 and a second host interface of the second communication device using the second frequency band. In some implementations, in establishing the first communication link between the first client interface of transceiver 430 and the first host interface of the second communication device using the first frequency band, process 600 may involve processor 410 receiving, via transceiver 430, a MAC address of the second host interface of the second communication device from the second communication device during an association phase between the first client interface of transceiver 430 and the first host interface of the second communication device. Moreover, in establishing the second communication link between the second client interface of transceiver 430 and the second host interface of the second communication device using the second frequency band, process 600 may involve processor 410 receiving, via transceiver 430, a MAC address of the first host interface of the second communication device from the second communication device during an association phase between the second client interface of transceiver 430 and the second host interface of the second communication device. Thus, processor 410 may detect whether the first communication link and the second communication link are duplicate of one another based on the MAC address of the first host interface and the MAC address of the second host interface of the second communication device.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a first communication device of a plurality of communication devices, a communication link with a second communication device of the plurality of communication devices to connect to the second communication device;
transmitting, by the first communication device and to the second communication device, a first action frame containing a unique identifier of the first communication device;
receiving, by the first communication device, a second action frame from a third communication device that is connected to the first communication device;
determining, by the first communication device, whether the second action frame meets a condition related to the unique identifier of the first communication device; and
performing either of:
disconnecting, by the first communication device, the communication link with the second communication device responsive to a determination that the second action frame meets the condition; or
maintaining, by the first communication device, the communication link with the second communication device responsive to a determination that the second action frame does not meet the condition and forwarding the second action frame.

2. The method of claim 1, wherein the unique identifier comprises a media access control (MAC) address of the first communication device.

3. The method of claim 1, wherein the establishing of the communication link with the second communication device comprises:
establishing the communication link with the second communication device using a first frequency band of two frequency bands with which the first communication device is configured to establish communication links; and
refraining from initiating to establish any communication link with any communication device using a second frequency band of the two frequency bands when establishing the communication link with the second communication device using the first frequency band.

4. The method of claim 1, wherein the second action frame contains a plurality of unique identifiers of a plurality of communication devices each of which having established a respective communication link within a predefined time interval.

5. The method of claim 1, wherein the determining of whether the second action frame meets the condition related to the unique identifier of the first communication device comprises:
identifying a highest unique identifier at top of a list of a plurality of unique identifiers of a plurality of communication devices contained in the second action frame;
determining whether the highest unique identifier is the unique identifier of the first communication device;
determining that the second action frame meets the condition related to the unique identifier of the first communication device responsive to a determination that the highest unique identifier is the unique identifier of the first communication device; and
determining that the second action frame does not meet the condition related to the unique identifier of the first communication device responsive to a determination that the highest unique identifier is not the unique identifier of the first communication device.

6. The method of claim 1, wherein the determining of whether the second action frame meets the condition related to the unique identifier of the first communication device comprises:
determining whether the unique identifier of the first communication device is listed twice in a list of a plurality of unique identifiers of a plurality of communication devices contained in the second action frame;
determining that the second action frame meets the condition related to the unique identifier of the first communication device responsive to a determination that the unique identifier of the first communication device is listed twice in the list of the plurality of unique identifiers; and
determining that the second action frame does not meet the condition related to the unique identifier of the first communication device responsive to a determination that the unique identifier of the first communication device is listed once in the list of the plurality of unique identifiers and not at top of the list.

7. The method of claim 1, further comprising:
responsive to the determination that the second action frame does not meet the condition, performing operations comprising:
adding the unique identifier of the first communication device to bottom of a list of unique identifiers of a plurality of communication devices contained in the second action frame; and
forwarding the second action frame to the second communication device.

8. A method, comprising:
establishing, by a first communication device of a plurality of communication devices, two communication links with a second communication device of the plurality of communication devices to connect to the second communication device using a first frequency band and a second frequency band;
receiving, by the first communication device, a packet via broadcast or multicast; and
forwarding, by the first communication device, the packet to at least some of the plurality of communication devices except for one of the plurality of communication devices from which the packet is received.

9. The method of claim 8, wherein the receiving of the packet comprises receiving the packet from a third communication device of the plurality of communication devices, and wherein the forwarding of the packet comprises forwarding the packet to the second communication device on either but not both of the two communication links.

10. The method of claim 8, wherein the plurality of communication devices comprise a first type of one or more communication devices not configured to support loop detection and a second type of one or more communication devices configured to support loop detection, and wherein the forwarding of the packet to at least some of the plurality of communication devices except for one of the plurality of communication devices from which the packet is received comprises:
forwarding the packet to every communication device of the one or more communication devices of the first type; and
forwarding the packet to every communication device of the one or more communication devices of the second type except for the one of the plurality of communication devices from which the packet is received.

11. The method of claim 8, wherein:
the establishing of the two communication links with the second communication device comprises:
establishing a first communication link between a first host interface of the first communication device and a first client interface of the second communication device using the first frequency band; and
establishing a second communication link between a second host interface of the first communication device and a second client interface of the second communication device using the second frequency band,
the establishing of the first communication link between the first host interface of the first communication device and the first client interface of the second communication device using the first frequency band comprises providing, by the first communication device, a media access control (MAC) address of the second host interface of the first communication device to the second communication device during an association phase between the first host interface of the first communication device and the first client interface of the second communication device, and
the establishing of the second communication link between the second host interface of the first communication device and the second client interface of the second communication device using the second frequency band comprises providing, by the first communication device, a MAC address of the first host interface of the first communication device to the second communication device during an association phase between the second host interface of the first communication device and the second client interface of the second communication device.

12. The method of claim 8, wherein:
the establishing of the two communication links with the second communication device comprises:
establishing a first communication link between a first host interface of the first communication device and a first client interface of the second communication device using the first frequency band; and
establishing a second communication link between a second host interface of the first communication device and a second client interface of the second communication device using the second frequency band,
the establishing of the first communication link between the first host interface of the first communication device and the first client interface of the second communication device using the first frequency band comprises receiving, by the first communication device, a media access control (MAC) address of the second client interface of the second communication device from the second communication device during an association phase between the first host interface of the first communication device and the first client interface of the second communication device,
the establishing of the second communication link between the second host interface of the first communication device and the second client interface of the second communication device using the second frequency band comprises receiving, by the first communication device, a MAC address of the first client interface of the second communication device from the second communication device during an association phase between the second host interface of the first communication device and the second client interface of the second communication device, and
the first communication device detects whether the first communication link and the second communication link are duplicate of one another based on the MAC address of the first client interface and the MAC address of the second client interface of the second communication device.

13. The method of claim 8, wherein:
the establishing of the two communication links with the second communication device comprises:
establishing a first communication link between a first client interface of the first communication device and a first host interface of the second communication device using the first frequency band; and
establishing a second communication link between a second client interface of the first communication device and a second host interface of the second communication device using the second frequency band,
the establishing of the first communication link between the first client interface of the first communication device and the first host interface of the second communication device using the first frequency band comprises providing, by the first communication device, a media access control (MAC) address of the second client interface of the first communication device to the second communication device during an association phase between the first client interface of the first communication device and the first host interface of the second communication device, and
the establishing of the second communication link between the second client interface of the first communication device and the second host interface of the second communication device using the second frequency band comprises providing, by the first communication device, a MAC address of the first client interface of the first communication device to the second communication device during an association phase between the second client interface of the first communication device and the second host interface of the second communication device.

14. The method of claim 8, wherein:
the establishing of the two communication links with the second communication device comprises:
establishing a first communication link between a first client interface of the first communication device and a first host interface of the second communication device using the first frequency band; and
establishing a second communication link between a second client interface of the first communication device and a second host interface of the second communication device using the second frequency band,
the establishing of the first communication link between the first client interface of the first communication device and the first host interface of the second communication device using the first frequency band comprises receiving, by the first communication device, a media access control (MAC) address of the second host interface of the second communication device from the second communication device during an association phase between the first client interface of the first communication device and the first host interface of the second communication device,
the establishing of the second communication link between the second client interface of the first communication device and the second host interface of the second communication device using the second frequency band comprises receiving, by the first communication device, a MAC address of the first host interface of the second communication device from the second communication device during an association phase between the second client interface of the first communication device and the second host interface of the second communication device, and
the first communication device detects whether the first communication link and the second communication link are duplicate of one another based on the MAC address of the first host interface and the MAC address of the second host interface of the second communication device.

15. An apparatus implementable in a first communication device of a plurality of communication devices, comprising:
a memory configured to store one or more sets of instructions; and
a processor coupled to access the memory to execute the one or more instructions and, upon executing the one or more sets of instructions, the processor is configured to perform operations comprising:
establishing a communication link with a second communication device of the plurality of communication devices to connect to the second communication device;
transmitting, to the second communication device, a first action frame containing a unique identifier of the first communication device;
receiving a second action frame from a third communication device that is connected to the first communication device;
determining whether the second action frame meets a condition related to the unique identifier of the first communication device; and
performing either of:
disconnecting the communication link with the second communication device responsive to a determination that the second action frame meets the condition; or
maintaining the communication link with the second communication device responsive to a determination that the second action frame does not meet the condition.

16. The apparatus of claim 15, wherein, in establishing the communication link with the second communication device, the processor is configured to perform operations comprising:
establishing the communication link with the second communication device using a first frequency band of two frequency bands with which the first communication device is configured to establish communication links; and
refraining from initiating to establish any communication link with any communication device using a second frequency band of the two frequency bands when establishing the communication link with the second communication device using the first frequency band.

17. The apparatus of claim 15, wherein, in determining whether the second action frame meets the condition related to the unique identifier of the first communication device, the processor is configured to perform operations comprising:
identifying a highest unique identifier at top of a list of a plurality of unique identifiers of a plurality of communication devices contained in the second action frame;
determining whether the highest unique identifier is the unique identifier of the first communication device;
determining that the second action frame meets the condition related to the unique identifier of the first communication device responsive to a determination that the highest unique identifier is the unique identifier of the first communication device; and
determining that the second action frame does not meet the condition related to the unique identifier of the first communication device responsive to a determination that the highest unique identifier is not the unique identifier of the first communication device.

18. The apparatus of claim 15, wherein, in determining whether the second action frame meets the condition related to the unique identifier of the first communication device, the processor is configured to perform operations comprising:
determining whether the unique identifier of the first communication device is listed twice in a list of a plurality of unique identifiers of a plurality of communication devices contained in the second action frame;
determining that the second action frame meets the condition related to the unique identifier of the first communication device responsive to a determination that the unique identifier of the first communication device is listed twice in the list of the plurality of unique identifiers; and
determining that the second action frame does not meet the condition related to the unique identifier of the first communication device responsive to a determination that the unique identifier of the first communication device is listed once in the list of the plurality of unique identifiers and not at top of the list.

19. The apparatus of claim 15, wherein the processor is further configured to perform operations comprising:
responsive to the determination that the second action frame does not meet the condition, performing operations comprising:
adding the unique identifier of the first communication device to bottom of a list of unique identifiers of a plurality of communication devices contained in the second action frame; and
forwarding the second action frame to the second communication device.

20. The apparatus of claim 15, wherein, in establishing the communication link with the second communication device, the processor is configured to perform operations comprising:
establishing two communication links with the second communication device using a first frequency band and a second frequency band;
receiving a packet via broadcast or multicast; and
forwarding the packet to at least some of the plurality of communication devices except for one of the plurality of communication devices from which the packet is received,
wherein the plurality of communication devices comprise a first type of one or more communication devices not configured to support loop detection and a second type of one or more communication devices configured to support loop detection, and
wherein the forwarding of the packet to at least some of the plurality of communication devices except for one of the plurality of communication devices from which the packet is received comprises:
forwarding the packet to every communication device of the one or more communication devices of the first type; and
forwarding the packet to every communication device of the one or more communication devices of the second type except for the one of the plurality of communication devices from which the packet is received.
